(19) United States
(12) Patent Application Publication
(10) Pub. No.: US 2018/0058670 A1
(43) Pub. Date: Mar. 1, 2018

(54) Lighting Suspension System

(71) Applicants: Todd Mitchell, Fithian, IL (US); Paula Mitchell, Fithian, IL (US)

(72) Inventors: Todd Mitchell, Fithian, IL (US); Paula Mitchell, Fithian, IL (US)

(21) Appl. No.: 15/248,175

(22) Filed: Aug. 26, 2016

(51) Int. Cl. F21V 21/096; F21S 4/10; F21V 21/088

(52) U.S. Cl. CPC F21V 21/096; F21W 2121/004; F21V 21/088; F21S 4/10

(57) ABSTRACT

A lighting suspension system for hanging Christmas lights includes a building that has a roof. The roof is comprised of a ferromagnetic material. A string of lights is provided. A plurality of retainers is provided. Each of the retainers magnetically engages the roof. Thus, each of the retainers is removably retained on the roof. Each of the retainers engages the string of lights. Thus, the string of lights is suspended from the roof to enhance an ornamental appearance of the roof.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to suspension devices and more particularly pertains to a new suspension device for hanging Christmas lights.

### BRIEF SUMMARY OF THE INVENTION

An embodiment of the disclosure meets the needs presented above by generally comprising a building that has a roof. The roof is comprised of a ferromagnetic material. A string of lights is provided. A plurality of retainers is provided. Each of the retainers magnetically engages the roof. Thus, each of the retainers is removably retained on the roof. Each of the retainers engages the string of lights. Thus, the string of lights is suspended from the roof to enhance an ornamental appearance of the roof.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a retainer of a lighting suspension system according to an embodiment of the disclosure.

FIG. 2 is a right side view of a retainer of an embodiment of the disclosure.

FIG. 3 is a bottom phantom view a retainer of an embodiment of the disclosure.

FIG. 4 is a perspective in-use view of an embodiment of the disclosure.

FIG. 5 is a front perspective in-use view of an embodiment of the disclosure.

### DETAILED DESCRIPTION OF THE INVENTION

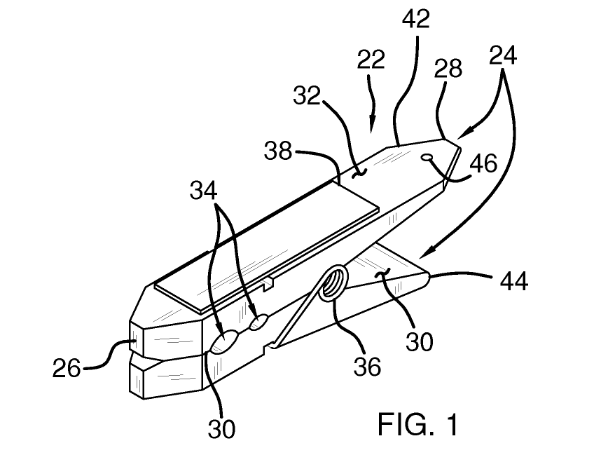

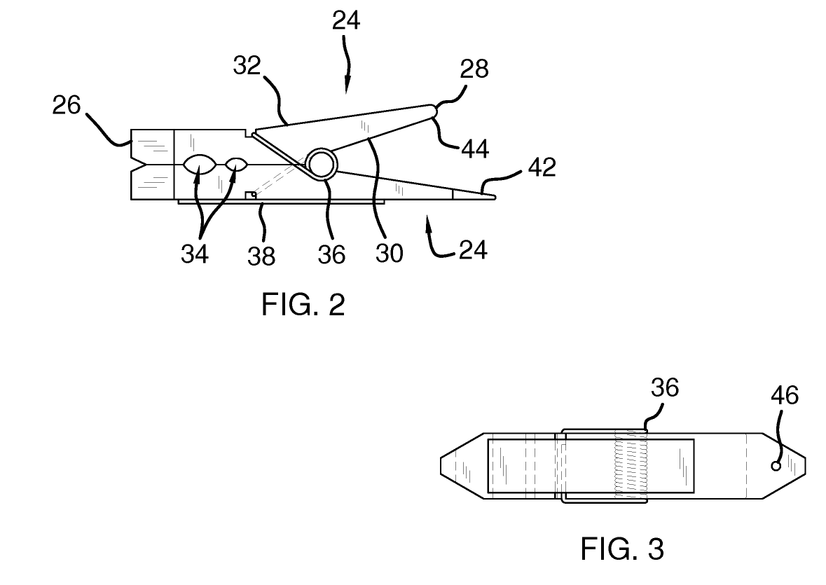

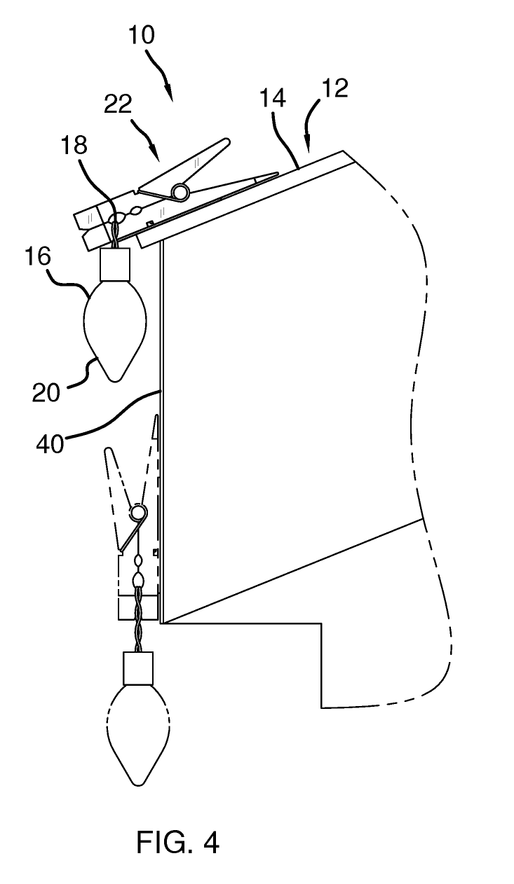

With reference now to the drawings, and in particular to FIGS. 1 through 5 thereof, a new suspension device embodying the principles and concepts of an embodiment of the disclosure and generally designated by the reference numeral 10 will be described.

As best illustrated in FIGS. 1 through 5, the lighting suspension system 10 generally comprises a building 12 that has a roof 14. The roof 14 may be comprised of a ferromagnetic material such as steel or the like. The building 12 may be a house or a commercial building 12. A string of lights 16 is provided. The string of lights 16 comprises at least one conductor 18 and a plurality of light emitters 20. Each of the light emitters 20 is electrically coupled to the at least one conductor 18. The string of lights 16 may comprise Christmas lights or the like.

A plurality of retainers 22 is provided. Each of the retainers 22 magnetically engages the roof 14. Thus, each of the retainers 22 is removably retained on the roof 14. Each of the retainers 22 engages the string of lights 16. Thus, the string of lights 16 is suspended from the roof 14 to enhance an ornamental appearance of the roof 14.

Each of the retainers 22 comprises a pair of jaws 24 and each of the jaws 24 may be manipulated. Each of the jaws 24 has a first end 26, a second end 28, an inwardly facing surface 30 and an outwardly facing surface 32. The inwardly facing surface 30 of each of the jaws 24 is hingedly coupled together. Each of the retainers 22 may comprise a clothes pin or the like. The inwardly facing surface 30 corresponding to each of the jaws 24 may have a plurality of grooves 34 extending toward the corresponding outwardly facing surface 32. The grooves 34 may be spaced apart from each other and distributed between the first end 26 and the second end 28 of the corresponding jaw 24.

A biasing member 36 is coupled to the inwardly facing surface 30 corresponding to each of the pair of jaws 24. The biasing member 36 biases the inwardly facing surface 30 corresponding to each of the jaws 24 to compress together. The biasing member 36 may comprise a spring or the like.

The second end 28 corresponding to each of the jaws 24 is spaced apart from each other. The inwardly facing surface 30 corresponding to each of the jaws 24 engages the at least one conductor 18. Thus, the pair of jaws 24 is removably coupled to the at least one conductor 18. The at least one conductor 18 may be positioned within a selected one of the grooves 34. Thus, jaws 24 are inhibited from pinching the at least one conductor 18.

A fastener 38 is provided. The fastener 38 is coupled to the outwardly facing surface 32 of an associated one of the jaws 24. The fastener 38 engages the roof 14 such that the pair of jaws 24 is retained on the roof 14. The fastener 38 comprises a magnet. Thus, the fastener 38 magnetically engages the roof 14. Thus, the roof 14 is not penetrated by a nail or the like.

The building 12 may include facia 40. The facia 40 may be comprised of a ferromagnetic material. Each of the retainers 22 may magnetically engage the facia 40. Thus, the string of lights 16 may be positioned on the facia 40. Each of the retainers 22 may be positioned to extend beyond a perimeter edge 42 of the roof 14. Thus, the string of lights 16 is suspended from the roof 14.

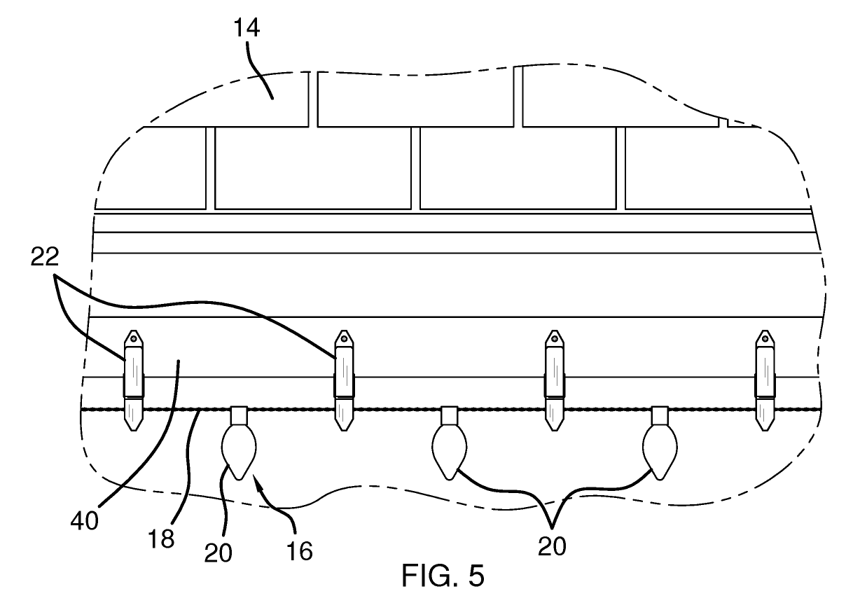

The pair of jaws 24 includes a first jaw 42 and a second jaw 44. The first jaw 42 has a length that is greater than a length of the second jaw 44. The fastener 38 is positioned on the first jaw 42. The first jaw 42 has an opening 46 extending through the inwardly facing surface 30 and the outwardly facing surface 32. The opening 46 is positioned beyond the second end 28 corresponding to the second jaw 44. As shown in FIG. 5, a screw or the like may be extended through the opening 46 to engage the roof 14. Thus, each of the retainers 22 is coupled to the roof 14.

In use, the fastener 38 corresponding to each of the retainers 22 engages the roof 14 to retain each of the retainers 22 on the roof 14. Each of the retainers 22 is manipulated to engage the at least one conductor 18. Thus, the string of lights 16 is coupled to the roof 14 without using penetrating fasteners or the like. The screw or the like is extended through the opening 46 in each of the retainers 22 and engages the roof 14 when the roof 14 is not comprised of a ferromagnetic material. Thus, each of the retainers 22 is coupled to the roof 14.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lighting suspension system comprising:
a building having a roof, said roof being comprised of a ferromagnetic material;
a string of lights comprising at least one conductor and a plurality of light emitters; and
a plurality of retainers, each of said retainers magnetically engaging said roof such that each of said retainers is removably retained on said roof, each of said retainers engaging said string of lights such that said string of lights is suspended from said roof wherein said string of lights is configured to enhance an ornamental appearance of said roof.

2. The system according to claim 1, wherein each of said retainers comprises a pair of jaws, each of said jaws being configured to be manipulated, each of said jaws having a first end, a second end, an inwardly facing surface and an outwardly facing surface, said inwardly facing surface of each of said jaws being hingedly coupled together.

3. The system according to claim 2, further comprising a biasing member being coupled to said inwardly facing surface corresponding to each of said pair of jaws, said biasing member biasing said inwardly facing surface corresponding to each of said jaws to compress together, said second end corresponding to each of said jaws being spaced apart from each other, said inwardly facing surface corresponding to each of said jaws engaging said conductor such that said pair of jaws is removably coupled to said at least one conductor.

4. The system according to claim 2, further comprising a fastener being coupled to said outwardly facing surface of an associated one of said jaws, said fastener engaging said roof such that said pair of jaws is retained on said roof.

5. A lighting suspension system comprising:
a building having a roof, said roof being comprised of a ferromagnetic material;
a string of lights comprising at least one conductor and a plurality of light emitters, each of said light emitters being electrically coupled to said at least one conductor; and
a plurality of retainers, each of said retainers magnetically engaging said roof such that each of said retainers is removably retained on said roof, each of said retainers engaging said string of lights such that said string of lights is suspended from said roof wherein said string of lights is configured to enhance an ornamental appearance of said roof, each of said retainers comprising:
a pair of jaws, each of said jaws being configured to be manipulated, each of said jaws having a first end, a second end, an inwardly facing surface and an outwardly facing surface, said inwardly facing surface of each of said jaws being hingedly coupled together,
a biasing member being coupled to said inwardly facing surface corresponding to each of said pair of jaws, said biasing member biasing said inwardly facing surface corresponding to each of said jaws to compress together, said second end corresponding to each of said jaws being spaced apart from each other, said inwardly facing surface corresponding to each of said jaws engaging said conductor such that said pair of jaws is removably coupled to said at least one conductor, and
a fastener being coupled to said outwardly facing surface of an associated one of said jaws, said fastener engaging said roof such that said pair of jaws is retained on said roof.
